(19) United States
(12) Patent Application Publication
(10) Pub. No.: US 2026/0327371 A1
(43) Pub. Date: Oct. 22, 2026

(54) RIGID POLYURETHANE FOAM

(71) Applicant: Dow Global Technologies LLC, Midland, MI (US)

(72) Inventors: Cecilia Girotti, Correggio (IT); Andrea Brandoli, Correggio (IT); Sven Neuhaus, Ahlen, Nw (DE); Weijun Zhou, Sugarland, TX (US)

(21) Appl. No.: 19/099,571

(22) PCT Filed: Sep. 20, 2023
(86) PCT No.: PCT/US2023/033210

§ 371 Date: Jan. 29, 2025

(30) Foreign Application Priority Data
Sep. 21, 2022 (IT) 102022000019350

(51) Int. Cl. C08G 18/48; C08G 18/08; C08G 18/18; C08J 9/08; C08J 9/14

(52) U.S. Cl. CPC C08G 18/4829; C08G 18/14; C08G 18/1816; C08J 9/08; C08J 9/146; C08G 2110/0025; C08G 2110/0041; C08G 2330/00; C08J 2203/02; C08J 2203/162; C08J 2375/08

(57) ABSTRACT

Embodiments of the present disclosure are directed towards a composition for making a rigid polyurethane foam for use, for example, with water heaters.

### FIELD OF DISCLOSURE

Embodiments of the present disclosure are directed towards a composition for preparing a rigid polyurethane foam.

### BACKGROUND

Water heaters are usually insulated with rigid polyurethane (PU) foam using various foaming technologies. The foaming technologies in turn depend on the final market and product requirements, technical and safety characteristics, cost, and performance needs for the water heater. To that end, different production processes for applying the rigid PU foam can be utilized. For example, an “on-fly” technique can be used to apply just enough PU foam to fill the cavity of the water heater under free rise conditions. Alternatively, the PU molding process can include over-packing the PU foam to maximize the mechanical strength performance of the rigid PU foam around the water heater. For example, in the molding process the rigid PU foam is injected against an external liner, usually a metal or a plastic one, or against a release agent when no external facings are used. In the latter case a water heater insulated with naked PU foam is initially obtained and it is afterwards covered with a removable external jacket. As a consequence, the produced PU foam must have, on top of good foam flow and fast curing properties, an excellent aesthetics with very few or no surface bubbles or defects. Visible bubbles or defects on the surface of the PU foam can result in unsightly surface defects of the final assembled water heater. As a result, there is a need in the art for PU foam systems that can make water heaters with acceptable product quality.

### SUMMARY

The present disclosure provides a fully formulated, non-flammable, zero ozone depletion (ODP)/low global warming potential (GWP) composition for preparing a rigid polyurethane (PU) foam that is suitable for molding process of naked foam especially those involving water heater applications. The disclosed composition allows the production of a PU foam featuring enhanced flow-properties plus excellent surface aesthetics and improved thermal insulation for long term use.

For the various embodiments, the composition for producing a rigid PU foam includes an isocyanate component that includes at least one polyisocyanate; and an isocyanate reactive system comprising: 5 to 30 weight percent (wt. %) of a first polyether polyol having an average hydroxyl number of from 100 to 600 mg KOH/g and an average hydroxyl functionality from 5.5 to 8; 45 to 75 wt. % of at least one second polyether polyol having an average hydroxyl number from 75 to 800 mg KOH/g and an average hydroxyl functionality of 2 to 3.2; 1 to 20 wt. % of a hydrofluoroolefin physical blowing agent; 1 to 5 wt. % of a chemical blowing agent comprising water; 0.5 to 5 wt. % of at least one surfactant; and 0.5 to 6 wt. % of at least one catalyst, where the wt. % are based on the total weight of the isocyanate reactive system and where the wt. % of the first polyether polyol, the at least one second polyether polyol, the hydrofluoroolefin physical blowing agent, the chemical blowing agent, the at least one surfactant and the at least one catalyst total 100 wt. % and where the isocyanate reactive system has an average hydroxyl functionality of 3.3 to 3.7, an average hydroxyl number from 300 to 400 mg KOH/g and does not contain formic acid.

The above summary of the present disclosure is not intended to describe each disclosed embodiment or every implementation of the present disclosure. The description that follows more particularly exemplifies illustrative embodiments. In several places throughout the application, guidance is provided through lists of examples, which examples can be used in various combinations. In each instance, the recited list serves only as a representative group and should not be interpreted as an exclusive list.

### DETAILED DESCRIPTION

The present disclosure provides a fully formulated, non-flammable, zero ozone depletion (ODP)/low global warming potential (GWP) composition for preparing a rigid polyurethane (PU) foam that is suitable for molding process of naked foam, especially those involving water heater applications. The disclosed composition allows the production of a PU foam featuring enhanced flow properties plus excellent surface aesthetics and improved thermal insulation for long term use. Such a composition is especially useful in the production of water heaters, where the PU foam of the present disclosure produces significantly fewer number of defects than traditional solutions, even at low mold temperature which better matches typical production conditions.

For the various embodiments, the composition for producing a rigid PU foam of the present disclosure includes an isocyanate component that includes at least one polyisocyanate and an isocyanate reactive system that comprises: (a) a first polyether polyol (b) at least one of a second polyether polyol, as provided herein, (c) a hydrofluoroolefin physical blowing agent, (d) a chemical blowing agent comprising water, (e) at least one surfactant; and (f) at least one catalyst. The isocyanate reactive system can further include a third polyether polyol (g) as discussed herein. As used herein, “polyol” refers to a compound having an average hydroxyl functionality of 2.0 or greater, such as diols, triols, tetrols, and such. A number of various polyols may be utilized for the isocyanate reactive system of this disclosure, such as those discussed herein, among other polyols known to those skilled in the art.

The composition for producing the rigid PU foam includes the isocyanate reactive system having the first polyether polyol. For the various embodiments, the first polyether polyol has an average hydroxyl functionality from 5.5 to 8.0. For example, the first polyether polyol can have an average hydroxyl functionality from a lower limit of 5.5, 5.7, 5.9, or 6.0 to an upper limit of 8.0, 7.8, 7.5, or 7.0. For the various embodiments, the first polyether polyol has an average hydroxyl number from 100 to 600 mg KOH/g. For example, the first polyether polyol can have an average hydroxyl number from a lower limit of 100, 110, 200, 250, 375, 400, 425 or 450 mg KOH/g to an upper limit of 600, 575, 550, 525 or 500 mg KOH/g. Hydroxyl number can be measured, for example, using ASTM E222-10.

The first polyether polyol can be an alcohol initiated polyether polyol, e.g., an alcohol initiated aliphatic or alicyclic polyether polyol. An alcohol initiator can have a hydroxyl functionality that is greater than 5.5 and/or a hydroxyl equivalent molecular weight that is less than 75 g/mol, e.g., from 15 g/mol to 60 g/mol, 20 g/mol to 50 g/mol, etc. Exemplary alcohol initiators that may be used are sorbitol and/or sucrose (alone or in combination with other initiators with a hydroxyl functionality that is equal to or less than 5.5), among other. Other initiators suitable for preparing the first polyether polyol can include mannitol, maltitol, trehalose, xylitol, and/or a mixture of these as long as the average hydroxyl functionality is from 5.5 to 8.0. For the various embodiments, the first polyether polyol is not prepared from a polyhydric alcohol initiator containing any aromatic unit or amine moiety.

The first polyether polyol can have a hydroxyl equivalent weight from 75 to 550 g/mol. As used herein, the hydroxyl equivalent weight is the weight of a compound per reactive site and is calculated according to the following equation: Equivalent Weight=(56.1×1000)/OH number. All individual values and subranges from 75 to 550 g/mol are included; for example, the first polyether polyol can have a hydroxyl equivalent weight from a lower limit of 75, 80, 85, 90, 95, or 100 to an upper limit of 550, 500, 400, 300, 250, 200, 175, 150, 145, or 140 g/mol.

The first polyether polyol can be prepared using known equipment and reaction conditions. The first polyether polyol may be obtained commercially. Examples of commercially available first polyether polyols include, but are not limited to, polyols sold under the trade name VORANOL™ such as VORANOL™ RN 482, VORANOL™ 280, VORANOL™ 370, all available from The Dow Chemical Company (DOW®), among others.

The first polyether polyol can be from 5 to 30 weight percent (wt. %) of a total weight of the isocyanate reactive system (components (a)-(f) or (a)-(g) as provided herein), where the wt. % of the first polyether polyol, the at least one second polyether polyol, the optional third polyether polyol, the hydrofluoroolefin physical blowing agent, the chemical blowing agent, the surfactant and the catalyst total 100 wt. %. All individual values and subranges from 5 to 30 wt. % are included; for example, the first polyether polyol can be from a lower limit of 5, 7, 9 or 11 wt. % to an upper limit of 30, 25, 20, 15 or 12 wt. % of the total weight of the isocyanate reactive system. For example, the first polyether polyol can be from 9 to 25 wt. % of the total weight of the isocyanate reactive system.

The isocyanate reactive system of the composition for producing the rigid PU foam also includes at least one second polyether polyol. For the various embodiments, each of the at least one second polyether polyol has an average hydroxyl functionality from 2 to 3.2. For example, each of the second polyether polyol can have an average hydroxyl functionality from a lower limit of 2, 2.2, 2.4 or 2.6 to an upper limit of 3.2, 3.15 or 3.1. For the various embodiments, each of the second polyether polyol has an average hydroxyl number from 75 to 800 mg KOH/g. For example, each of the second polyether polyol can have an average hydroxyl number from a lower limit of 75, 80, 90, 100, 110, 120, 140 or 150 mg KOH/g to an upper limit of 800, 750, 725, 700 or 670 mg KOH/g. By way of example, each of the second polyether polyol(s) can have an average hydroxyl number from 100 to 750 mg KOH/g; 120 to 700 mg KOH/g or 150 to 700 mg KOH/g, among other ranges. Each of the second polyether polyol(s) may have a number average molecular weight, independently, in the range of 150 g/mol to 1500 g/mol; in the range of 800 to 1200 g/mol; in the range of greater than 350 to 650 g/mol; or in the range of 150 to 350 g/mol.

The second polyether polyol(s) can be from 45 to 75 wt. % of the total weight of the isocyanate reactive system (components (a)-(f) or (a)-(g) as provided herein), where the wt. % of the first polyether polyol, the at least one second polyether polyol, optionally the third polyether polyol, the hydrofluoroolefin physical blowing agent, the chemical blowing agent, the at least one surfactant and the at least one catalyst total 100 wt. %. All individual values and subranges from 45 to 75 weight percent are included; for example, the second polyether polyol(s) can be from a lower limit of 45, 50, 55 or 60 wt. % to an upper limit of 75, 72 or 65 wt. % of the total weight of the isocyanate reactive system. For example, the at least one second polyether polyol can be from 55 to 72 wt. % of the total weight of the isocyanate reactive system. For the various embodiments, the isocyanate reactive system can include 5 to 30 wt. % of the first polyether polyol and 45 to 75 wt. % of the at least one second polyether polyol where the wt. % of the first polyether polyol, the at least one second polyether polyol, the optional third polyether polyol, the hydrofluoroolefin physical blowing agent, the chemical blowing agent, the surfactant and the catalyst total 100 wt. %. In an additional embodiment, the isocyanate reactive system can include 7 to 25 wt. % of the first polyether polyol and 50 to 72 wt. % of the at least one second polyether polyol where the wt. % of the first polyether polyol, the at least one second polyether polyol, the optional third polyether polyol, the hydrofluoroolefin physical blowing agent, the chemical blowing agent, the surfactant and the catalyst total 100 wt. %. For the present embodiments, the first polyether polyol can be a sorbitol initiated polyether polyol and the at least one second polyether polyol can be at least one of a glycerin initiated polyether polyol, each as provided herein.

Each of the second polyether polyol(s) can be an alcohol initiated polyether polyol, e.g., an alcohol initiated aliphatic or alicyclic polyether polyol. Each of the second polyether polyol(s), for example, can be obtained conventionally by reacting alkylene oxides (such as ethylene oxide, propylene oxide or butylene oxide) with a polyol or polyhydroxy alcohol initiator. Examples of suitable initiators include ethylene glycol; diethylene glycol; propylene glycol; dipropylene glycol; tripropylene glycol; 1,4-butanediol; 1,6-hexane diol; cycloaliphatic diols such as 1,4-cyclohexane diol, glycerin, trimethanoyl propane and triethanolamine. Catalysts for the polymerization can be either anionic catalysts or cationic catalysts, with exemplary catalysts such as potassium hydroxide (KOH), boron trifluoride, or double cyanide complex catalysts such as zinc hexacyanocobaltate. In some embodiments, each of the second polyether polyol(s) is obtained using propylene oxide. For the various embodiments, the at least one second polyether polyol comprises at least one glycerine-initiated polyether polyol having a number average molecular weight in the range of 150 to 1500 g/mol.

Each of the second polyether polyol(s) can be a glycerine-initiated polyether polyol prepared using known equipment and reaction conditions. Each of the second polyether polyol(s) may be obtained commercially. Suitable commercially available polyether polyols include VORANOL™ 220-110, VORATEC™ SD301, VORANOL™ CP 260, VORANOL™ CP 450, VORANOL™ CP 755, VORANOL™ CP 1000, VORANOL™ CP 1050 and VORANOL™ CP 1055, available from DOW®.

Each of the second polyether polyol(s) can be present in the isocyanate reactive system in a variety of weight percentages, where the second polyether polyol(s) constitute, as discussed herein, 45 to 75 wt. % of the isocyanate reactive system, more preferably from 50 to 75 wt. % of the isocyanate reactive system. For example, the at least one second polyol can include 5 to 20 wt. % of a first glycerine-initiated polyether polyol having a number average molecular weight of 800 to 1200 g/mol; 30 to 45 wt. % of a second glycerine-initiated polyether polyol having a number average molecular weight of greater than 350 to 650 g/mol; and 10 to 25 wt. % of a third glycerine-initiated polyether polyol having a number average molecular weight of 150 to 350 g/mol, where the wt. % values of the first glycerine-initiated polyether polyol, the second glycerine-initiated polyether polyol and the third glycerine-initiated polyether polyol provide the 45 to 75 wt. % of the at least one second polyether polyol. In an alternative embodiment, the at least one second polyol can include 7 to 17 wt. % of a first glycerine-initiated polyether polyol having a number average molecular weight of 800 to 1200 g/mol; 30 to 40 wt. % of a second glycerine-initiated polyether polyol having a number average molecular weight of greater than 350 to 650 g/mol; and 14 to 20 wt. % of a third glycerine-initiated polyether polyol having a number average molecular weight of 150 to 350 g/mol, where the combined wt. % values of the first glycerine-initiated polyether polyol, the second glycerine-initiated polyether polyol and the third glycerine-initiated polyether polyol provide the 45 to 75 wt. % of the at least one second polyether polyol.

The isocyanate reactive system of the composition for producing the rigid PU foam can also optionally include a third polyether polyol. For the various embodiments, each of the third polyether polyol has an average hydroxyl functionality of greater than 3.2 to 5. For example, the third polyether polyol can have an average hydroxyl functionality from a lower limit of greater than 3.2, 3.3, 3.4, 3.5, 3.6, 3.7, 3.8, 3,9 4.0, 4.1 or 4.2 to an upper limit of 5, 4.9, 4.8, 4.7, 4.6, 4.5 or 4.4. For the various embodiments, the third polyether polyol has an average hydroxyl number from 100 to 750 mg KOH/g. For example, the third polyether polyol can have an average hydroxyl functionality from a lower limit of 100, 150, 200, 250, 275, 300, or 325 mg KOH/g to an upper limit of 750, 650, 600, 550, 500, 450, 425, 400, or 375 mg KOH/g. By way of example, the third polyether polyol can have an average hydroxyl number from 200 to 600 mg KOH/g; 300 to 550 mg KOH/g or 350 to 450 mg KOH/g, among other ranges. The third polyether polyol may have a number average molecular weight in the range of 250 g/mol to 3000 g/mol; in the range of 350 g/mol to 2500 g/mol; in the range of 400 g/mol to 2000 g/mol; in the range of 500 g/mol to 1500 g/mol; in the range of 600 g/mol to 1000 g/mol; in the range of 600 to 800 g/mol; or in the range of 650 to 750 g/mol.

The third polyether polyol can be from 5 to 15 wt. % of the total weight of the isocyanate reactive system (components (a)-(g) as provided herein), where the wt. % of the first polyether polyol, the at least one second polyether polyol, the third polyether polyol, the hydrofluoroolefin physical blowing agent, the chemical blowing agent, the surfactant and the catalyst total 100 wt. %. All individual values and subranges from 5 to 15 weight percent are included; for example, the third polyether polyol can be from a lower limit of 5, 5.5 or 6.5 wt. % to an upper limit of 15, 12.5, 11, 10, 9.5 or 8.5 wt. % of the total weight of the isocyanate reactive system. For example, the third polyether polyol can be from 6.5 to 8.5 wt. % of the total weight of the isocyanate reactive system. For the various embodiments, the isocyanate reactive system can then include 5 to 30 wt. % of the first polyether polyol; 45 to 75 wt. % of the at least one second polyether polyol and optionally 5 to 15 wt. % of the optional third polyether polyol, where the wt. % of the first polyether polyol, the at least one second polyether polyol, the optional third polyether polyol, the hydrofluoroolefin physical blowing agent, the chemical blowing agent, the surfactant and the catalyst total 100 wt. %. In an additional embodiment, the isocyanate reactive system can include 9 to 25 wt. % of the first polyether polyol, 50 to 72 wt. % of the at least one second polyether polyol and 5 to 10 wt. % of the optional third polyether polyol, where the wt. % of the first polyether polyol, the at least one second polyether polyol, the optional third polyether polyol, the hydrofluoroolefin physical blowing agent, the chemical blowing agent, the surfactant and the catalyst total 100 wt. %.

The third polyether polyol can be an alcohol initiated polyether polyol, e.g., an alcohol initiated aliphatic or alicyclic polyether polyol. The third polyether polyol, for example, can be obtained conventionally by reacting alkylene oxides (such as ethylene oxide, propylene oxide or butylene oxide) with a polyol or polyhydroxy alcohol initiator. Examples of suitable initiators include pentaerythritol; xylitol; a blend of a sugar alcohol such as sucrose with another alcohol having two or three hydroxyl groups such as ethylene glycol, diethylene glycol, propylene glycol, dipropylene glycol, tripropylene glycol, 1,4-butanediol, 1,6-hexane diol, cycloaliphatic diols such as 1,4-cyclohexane diol, glycerin, trimethanoyl propane and triethanolamine. Catalysts for the polymerization can be either anionic catalysts or cationic catalysts, with exemplary catalysts such as potassium hydroxide (KOH), boron trifluoride, or double cyanide complex catalysts such as zinc hexacyanocobaltate. In some embodiments, the third polyether polyol is obtained from using propylene oxide. For the various embodiments, the third polyether polyol comprises at least one sucrose/glycerine-initiated polyether polyol having a number average molecular weight in the range of 500 to 900 g/mol.

The third polyether polyol can be a sucrose/glycerine-initiated polyoxypropylene polyol prepared using known equipment and reaction conditions. The third polyether polyol may be obtained commercially. Suitable commercially available polyether polyols include VORANOL 520, VORANOL™ RN 490, VORANOL™ 466, VORANOL™ 446, VORANOL™ RH 360, all available from DOW®.

For the various embodiments, neither the first polyether polyol, the at least one second polyether polyol or the optional third polyether polyol is prepared from a polyhydric alcohol initiator containing any aromatic unit or amine moiety.

Embodiments of the present disclosure provide that the isocyanate reactive system further include 1 to 20 wt. % of a hydrofluoroolefin physical blowing agent, where the wt. % is based on the total weight of the isocyanate reactive system. All individual values and subranges from 1 to 20 wt. % of the hydrofluoroolefin physical blowing agent are included; for example, the hydrofluoroolefin physical blowing agent can be from a lower limit of 1, 2, 5, or 8 wt. % to an upper limit of 20, 18, 14 or 12 wt. % of the total weight of the isocyanate reactive system.

Examples of the hydrofluoroolefin physical blowing agent suitable for this invention include both unsaturated hydrofluoroolefins (HFO) and unsaturated hydrochlorofluoroolefin (HCFO). They have negligible (low or zero) ozone-depletion and low global warming potential. Suitable HFO and HCFO blowing agents include but not limited to cis-1,1,1,4,4,4-Hexafluoro-2-butene (HFO-1336mzz(Z)), trans-1,1,1,4,4,4-hexafluoro-2-butene (HFO-1336mzz(E)), 1,1,1,4,4,5,5,5-octafluoro-2-pentene (HFO-1438mzz), 2,3,3,3-tetrafluoropropene (HFO-1234yf), trans 1,3,3,3-Tetrafluoroprop-1-ene (HFO 1234ze), heptafluorobutene isomer (HFO1327), heptafluoropentene isomers (HFO1447), octafluoropentene isomers (HFO1438), nonafluoropentene (HFO1429) dichlorotrifluoropropene (HCFO-1223), 1-chloro-3,3,3-trifluoropropene (HCFO-1233zd), 2-chloro-3,3,3-trifluoropropene (HCFO-1233xf) and mixtures thereof, etc. Some of these blowing agents are commercially available materials known as Solstice® LBA, Solstice® GBA, Opteon™ 1100, Opteon™ 1150, etc. Hydrofluoroolefin physical blowing agents that do not contain any chlorine atom are more preferred for use in this invention.

Embodiments of the present disclosure provide that the isocyanate reactive system further include 1 to 5 wt. % of a chemical blowing agent comprising water, where the wt. % is based on the total weight of the isocyanate reactive system. All individual values and subranges from 1 to 5 wt. % of the chemical blowing agent comprising water; for example, the chemical blowing agent can be from a lower limit of 1, 1.5, 2 or 2.5 wt. % to an upper limit of 5, 4 or 3.5 wt. % of the total weight of the isocyanate reactive system. Additional chemical blowing agents may be used are those CO₂ generating materials that are not based on organic acids.

Preferably, the chemical blowing agent is water. For the various embodiments, the chemical blowing agent does not contain any formic acid.

Embodiments of the present disclosure provide that the isocyanate reactive system further include 0.5 to 6 wt. % of at least one catalyst, where the wt. % is based on the total weight of the isocyanate reactive system. All individual values and subranges from 0.5 to 6 wt. % of the at least one catalyst are included; for example, the at least one catalyst can be from a lower limit of 0.5, 1, 2 or 3 wt. % to an upper limit of 6, 5 or 4 wt. % of the total weight of the isocyanate reactive system.

For the various embodiments, the at least one catalyst may be a blowing catalyst, a gelling catalyst, a trimerization catalyst, or combinations thereof. As used herein, blowing catalysts and gelling catalysts, may be differentiated by a tendency to favor either the urea (blow) reaction, in the case of the blowing catalyst, or the urethane (gel) reaction, in the case of the gelling catalyst. A trimerization catalyst may be utilized to promote reactivity of the foam formulations. For the various embodiments, the amount of any one individual catalyst in the at least one or more catalysts can be as low as 0.1 to 0.2 wt. % or less.

Examples of blowing catalysts, e.g., catalysts that can tend to favor the blow reaction include, but are not limited to, short chain tertiary amines or tertiary amines containing an oxygen. For instance, blowing catalysts include bis-(2-dimethylaminoethyl) ether; pentamethyldiethylene-triamine, triethylamine, tributyl amine, N,N-dimethylaminopropylamine, dimethylethanolamine, N,N,N′,N′-tetra-methylethylenediamine, and combinations thereof, among others.

Examples of gelling catalysts, e.g., catalyst that can tend to favor the gel reaction, include, but are not limited to, organometallic compounds, cyclic tertiary amines and/or long chain amines, e.g., that contain several nitrogen atoms, and combinations thereof. Organometallic compounds include organotin compounds, such as tin(II) salts of organic carboxylic acids, e.g., tin(II) diacetate, tin(II) dioctanoate, tin(II) diethylhexanoate, and tin(II) dilaurate, and dialkyltin(IV) salts of organic carboxylic acids, e.g., dibutyltin diacetate, dibutyltin dilaurate, dibutyltin maleate and dioctyltin diacetate. Bismuth salts of organic carboxylic acids may also be utilized as the gelling catalyst, such as, for example, bismuth octanoate. Cyclic tertiary amines and/or long chain amines include dimethylbenzylamine, N,N,N′,N′-tetramethylbutanediamine, dimethylcyclohexylamine, triethylenediamine, and combinations thereof, and combinations thereof.

Examples of trimerization catalysts include tris(dialkylaminoalkyl)-s-hexahydrotriazines, such as 1,3,5-tris(N,N-dimethylaminopropyl)-s-hexahydrotriazine; [2,4,6-Tris(dimethylaminomethyl) phenol]; N-(2-hydroxylpropyl)-N-tri-methyl ammoniumformate, potassium acetate, potassium octoate; tetraalkylammonium hydroxides such as tetramethylammonium hydroxide; alkali metal hydroxides such as sodium hydroxide; alkali metal alkoxides such as sodium methoxide and potassium isopropoxide; and alkali metal salts of long-chain fatty acids having 10 to 20 carbon atoms and, combinations thereof. Some commercially available trimerization catalysts include DABCO® TMR, DABCO® TMR-2, DABCOR TMR-30, DABCOR K 2097; DABCOR K15, POLYCAT® 41, POLYCAT® 43, and POLYCAT® 46, among others.

Embodiments of the present disclosure provide that the isocyanate reactive system further include 0.5 to 5 wt. % of at least one surfactant, where the wt. % is based on the total weight of the isocyanate reactive system. All individual values and subranges from 0.5 to 5 wt. % of the at least one surfactant are included; for example, the at least one surfactant can be from a lower limit of 0.5, 1, 2 or 2.5 wt. % to an upper limit of 5, 4 or 3.5 wt. % of the total weight of the isocyanate reactive system.

For the various embodiments, examples of the at least one surfactant include silicon-based compounds organosilicone-polyether copolymers, such as polydimethyl siloxane and polydimethylsiloxane-polyoxyalkylene block copolymers, e.g., polyether modified polydimethyl siloxane, and combinations thereof. Examples of surfactants also include non-silicone based organic surfactants such as nonylphenol ethoxylates, VORASURF™ 504, available from The Dow Chemical Company. Silicone surfactants are available commercially and include those available under trade names such as NIAX™, such as NIAX™ L 6900 and NIAX™ L 6988; DABCO™; and TEGOSTAB™ such as TEGOSTAB™ B 8427 and TEGOSTAB™ B 8491, among others.

One or more embodiments of the present disclosure provide that the composition for producing the rigid PU foam can include one or more additional components. Different additional components and/or different amounts of the additional components may be utilized for various applications. Examples of additional components include pigments, colorants, flame retardants, crosslinkers, chain extenders, antioxidants, bioretardant agents, and combinations thereof, among others.

For the various embodiments, the isocyanate reactive system disclosed herein has an average hydroxyl functionality of 3.3 to 3.7 and an average hydroxyl number from 300 to 400 mg KOH/g. The average hydroxyl number can be determined from a wet analytical method for the hydroxyl content of a polyol as milligrams of potassium hydroxide equivalent to the hydroxyl content in one gram of polyol or other hydroxyl compound. The hydroxyl number can be expressed by the following formula:

$$OH Number = \frac{56.1 \times 1000}{Equi v alent Weight}$$

where 56.1 is the atomic weight of potassium hydroxide and 1000 is a number of milligrams in one gram of sample. The hydroxyl number for the isocyanate reactive system disclosed herein can be determined as the weighted sum of the respective hydroxyl numbers of the first polyether polyol, the at least one second polyether polyol, the optionally the third polyether polyol, and all potential additives, including catalysts and surfactants, that present a hydroxyl number. All individual values and subranges for the average hydroxyl functionality of 3.3 to 3.7 and the average hydroxyl number of 300 to 400 mg KOH/g are included. For example, the average hydroxyl functionality can be from a lower limit of 3.3, 3.35 or 3.4 to an upper limit of 3.7, 3.65 or 3.6; and the average hydroxyl number can be from a lower limit of 300, 320, or 330 mg KOH/g to an upper limit of 400, 380, 370 or 360 mg KOH/g. In all cases, the isocyanate reactive system does not contain formic acid.

For the various embodiments, ASTM D 1957 and ASTM E222-10 also describe methods of determining the hydroxyl number as provided herein.

The composition for producing the rigid PU foam further comprises an isocyanate component that includes at least one polyisocyanate. As used herein, “polyisocyanate” refers to a molecule having an average of greater than 1.0 isocyanate groups/molecule, e.g., an average functionality of greater than 1.0.

The isocyanate component can be an aliphatic polyisocyanate, a cycloaliphatic polyisocyanate, an araliphatic polyisocyanate, an aromatic polyisocyanate, or combinations thereof, for example. Examples of isocyanates include, but are not limited to, toluene 2,4-/2,6-diisocyanate (TDI), methylenediphenyl diisocyanate (MDI), polymeric MDI, triisocyanatononane (TIN), naphthyl diisocyanate (NDI), 4,4′-diisocyanatodicyclohexylmethane, 3-isocyanatomethyl-3,3,5-trimethylcyclohexyl isocyanate (isophorone diisocyanateIIPDI), tetramethylene diisocyanate, hexamethylene diisocyanate (HDI), 2-methylpentamethylene diisocyanate, 2,2,4-trimethylhexamethylene diisocyanate (THDI), dodecamethylene diisocyanate, 1,4-diisocyanatocyclohexane, 4,4′-diisocyanato-3,3′-dimethyldicyclohexylmethane, 4,4′-diisocyanato-2,2-dicyclohexylpropane, 3-isocyanatomethyl-1-methyl-1-isocyanatocyclohexane (MCI), 1,3-diisooctylcyanato-4-methylcyclohexane, 1,3-diisocyanato-2-methylcyclohexane, and combinations thereof, among others. As well as the isocyanates mentioned above, partially modified polyisocyanates including uretdione, isocyanurate, carbodiimide, uretonimine, allophanate or biuret structure, and combinations thereof, among others, may be utilized.

The isocyanate component can be polymeric. As used herein “polymeric”, in describing the isocyanate component, refers to higher molecular weight homologues and/or isomers. For instance, polymeric methylene diphenyl isocyanate refers to a higher molecular weight homologue and/or an isomer of methylene diphenyl isocyanate.

As mentioned, the isocyanate component can have an average functionality of greater than 1.0 isocyanate groups/molecule. For instance, the isocyanate component can have an average functionality from 1.75 to 3.50. All individual values and subranges from 1.75 to 3.50 are included; for example, the isocyanate component can have an average functionality from a lower limit of 1.75, 1.85, or 1.95 to an upper limit of 3.50, 3.40 or 3.30.

The isocyanate component can have an isocyanate equivalent weight 80 g/eq to 300 g/eq. All individual values and subranges from 80 to 300 g/eq are included; for example, the isocyanate component can have an isocyanate equivalent weight from a lower limit of 80, 90, 100, 125, 135, or 145 to an upper limit of 300, 290, or 280 g/eq.

The isocyanate component may be prepared by a known process. For instance, the polyisocyanate can be prepared by phosgenation of corresponding polyamines with formation of polycarbamoyl chlorides and thermolysis thereof to provide the polyisocyanate and hydrogen chloride, or by a phosgene-free process, such as by reacting the corresponding polyamines with urea and alcohol to give polycarbamates, and thermolysis thereof to give the polyisocyanate and alcohol, for example.

The isocyanate component may be obtained commercially. Examples of commercial isocyanates include, but are not limited to, polyisocyanates under the trade names VORANATE™, such as VORANATE™ M 220, and PAPI™ such as PAPI™ 27, available from DOW®, among other commercial isocyanates.

The isocyanate component can be utilized such that the composition for producing the rigid PU foam has an isocyanate index in a range from 100 to 150. Isocyanate index can be determined as a quotient, multiplied by one hundred, of an actual amount of isocyanate utilized and a theoretical amount of isocyanate required for completely reacting all the active hydrogen groups present in the isocyanate reactive system. All individual values and subranges from 100 to 150 are included; for example, the foam formulation can have an isocyanate index from a lower limit of 100, 110, or 120 to an upper limit of 150, 140, or 130.

The composition for producing the rigid PU foam disclosed herein can be cured to form a rigid PU foam having a core density of greater than 30 kg/m³. As used herein, the core density of a PU foam is determined from the middle interior section of a molded foam as its mass per unit of volume. The foam core density is generally lower than the apparent density calculated by dividing the foam mass by its entire volume due to the density variation from skin to core in the molded foam. The rigid PU foam can be prepared by using known methods and conditions, which may vary for different applications. One or more embodiments of the present disclosure provide a process for forming a foam product. For the various embodiments, the composition for producing the rigid PU foam is applied to a water heater. The process includes curing the foam formulations disclosed herein. The process may utilize known equipment and conditions, such as a one shot process, among others.

The foam product disclosed herein may be a closed-cell foam. As used herein, a “closed-cell foam” refers to a foam having an open cell volume percentage of less than or equal to 10 percent. The foam product can have an open cell volume percentage from 1 volume percent to 10 volume percent. All individual values and subranges from 1 to 10 volume percent are included; for example, the foam product can have an open cell volume percentage from a lower limit of 1, 2, 3, 4, or 5 volume percent to an upper limit of 10, 9, or 8 volume percent. The open cell content is measured in accordance with ASTM D-6226 using a pycnometer such as AccuPyc 1330 from Micromeretics (Norcross, GA) equipped with the FoamPyc option for calculation of open cell content.

For the various embodiments, the isocyanate component and the isocyanate reactive system react to produce a rigid PU foam having an average cross-linking molecular weight in the range of 420 to 500 g/mole. Average cross-linking molecular weight may be determined as discussed further herein. All individual values and subranges from 420 to 500 are included; for example, the rigid PU foam can have an average cross-linking molecular weight from a lower limit of 420, 430, 435, or 440 to an upper limit of 500, 490, 480, 470, or 460.

The average cross-linking molecular weight is the number average molecular weight per crosslink, which is determined using the following formula:

$${M}_{c} = \frac{{W}_{POL} + {W}_{ISO}}{\frac{{W}_{POL} ( {F}_{POL} - 2 )}{{E}_{POL} \times {F}_{POL}} + \frac{{W}_{ISO , STOICH} ( {F}_{ISO} - 2 )}{{E}_{ISO} \times {F}_{ISO}} + \frac{{W}_{ISO , EXC} ( {F}_{ISO} - 1 )}{{E}_{ISO} \times ( {F}_{ISO} + 1 )}}$$

where Mc is the average cross-linking molecular weight, W_{POL} is a combined weight of polyol utilized to form the foam, W_{ISO, STOICH} is a weight of the stoichiometric amount of isocyanate in grams, W_{ISO, EXC} is a weight of the isocyanate exceeding the stoichiometric amount of isocyanate, F_{ISO} is a numerical average functionality of the isocyanate, F_{POL} is a numerical average functionality of the polyol utilized, E_{ISO} is an equivalent weight of the isocyanate, and E_{POL} is an equivalent weight of the polyol utilized. The values for the average cross-linking molecular weight provide an idea of how much the polymer is branched. The higher the average cross-linking molecular weight the lower the crosslink density.

As mentioned, the rigid PU foam disclosed herein can have one or more advantageous properties, as compared to foams prepared from other formulations. For instance, the rigid PU foam disclosed herein can have an advantageously improved, i.e., reduced, surface defects, good foam processing, as compared to foams formed from other less preferred formulations. Reduced surface defects may be desirable for a number of applications. One example, as will be evident to those skilled in the art, of such applications is water heaters foamed with a molding process where the PU reacting mixture is injected directly against a release agent. The produced naked PU foam must have, on top of good foam flow and fast curing properties, an excellent aesthetics with very few or no surface bubbles or defects.

The rigid PU foam disclosed herein also exhibits an advantageously improved thermal insulation performance, particularly over the long term use. Thermal conductivity of the rigid PU foam disclosed herein after 50 days aging at room temperature is no higher than 25 mW/m-K, preferably no higher than 24 mW/m-K, and even more preferably no higher than 23.5 mW/m-K.

### Examples

In the Examples (Ex) and Comparative Examples (CE), various terms and designations for materials are used including, for instance, the following: VORANOL™ RN 482 (sorbitol initiated propoxylated polyol; average functionality 6.0; equivalent weight 117 g/mol; hydroxyl number 477 mg KOH/g; obtained from the Dow Chemical Company); VORANOL™ CP 1055 (aliphatic polyether polyol; average functionality 3.0; equivalent weight 360 g/mol; hydroxyl number 156 mg KOH/g; obtained from the Dow Chemical Company); VORANOL™ P1010 (diol; aliphatic polyether diol; average functionality 2.0; equivalent weight 510 g/mol; hydroxyl number 110 mg KOH/g; obtained from The Dow Chemical Company); VORANOL™ CP 450 (aliphatic polyether polyol; average functionality 3.0; equivalent weight 148 g/mol; hydroxyl number 383 mg KOH/g; obtained from The Dow Chemical Company); VORANOL™ CP 260 (aliphatic polyether polyol; average functionality 3.0; equivalent weight 85 g/mol; hydroxyl number 662 mg KOH/g; obtained from The Dow Chemical Company); VORANOL™ RH 360 (aliphatic polyether polyol; average functionality 4.6; equivalent weight 156 g/mol; hydroxyl number 360 mg KOH/g; obtained from the Dow Chemical Company); dimethylcyclohexylamine [DMCHA] (gelling catalyst; obtained from BordsoChem); pentamethyldiethylene-triamine [PMDETA] (blowing catalyst; obtained from Evonik); dimethylbenzylamine [DMBA] (gelling catalyst; obtained from EVONIK™); DABCOR TMR-2 (trimerization catalyst, obtained from EVONIK™); NIAX™ L-6988 (silicone surfactant; obtained from Momentive Performance Materials Inc.); TEGOSTAB™ B 8491 (silicon surfactant; obtained from EVONIK™); NIAX™ L 6900 (surfactant; obtained from MOMENTIVE™); deionized (DI) water (chemical blowing agent); formic acid (chemical blowing agent, obtained from Sigma-Aldrich®); Solstice® LBA (trans 1-chloro-3,3,3-trifluoropropene; physical blowing agent; obtained from Honeywell International Inc.); Opteon® 1100 (1,1,1,4,4,4-hexafluoro-2-butene; physical blowing agent; obtained from The Chemours Company FC, LLC); VORANATE™ M 220 (isocyanate; polymeric MDI; wt. % of NCO=31.4%, average functionality of NCO group of 2.7, obtained from The Dow Chemical Company).

### Experimental Procedure

Ex and CE foam samples and molded panels were prepared using an A40 high pressure (HP) injection machine and dispensing equipment from Cannon Afros (Cannon S.p.A., Italy) equipped with FPL-14 L-shaped mixing heads (Cannon S.p.A., Italy). Molded panels were prepared using a Brett mold of dimensions 200 cm×20 cm×5 cm, a Super Brett mold of dimensions 200 cm×20 cm×10 cm, or a Jumbo mold of dimensions 70 cm×40 cm×10 cm. Process conditions were kept same for all the foam sample preparation as follows, polyol and isocyanate mixing pressure: 150 bars; temperature: 20-22° C.; output rate: 200 gram/sec. Physical properties were tested on foams prepared with the standard Brett mold at the mold temperature of 40° C. and 10% and 15% over-pack over the Brett mold's minimal fill density (MFD). Demold expansion measurements were taken from panels produced with the Jumbo mold at the mold temperature of 40° C. and 10% over-pack over the Brett's MFD.

Cream time was observed visually. Gel time was evaluated by touching the surface of the curing reaction mixture periodically with a wood tongue depressor. The gel time is the time after the polyisocyanate and formulated polyol composition are mixed at which strings begin to form when the wood tongue depressor is pulled away. Tack-free time is the time at which the surface of the foam is no longer tacky to the touch. Free rise density (FRD) was measured according to ASTM D 6226.

Molded foam samples taken from the Brett mold were used to measure various foam properties: minimum filling density (MFD), average density distribution (ADD), compressive strength (CS), dimensional stability (DS), and thermal conductivity (also called Lambda or k-factor). MFD is the density determined from the minimum weight needed to fill the in-mold cavity completely and the volume of this in-mold cavity. MFD is reported in kg/m³. The average density deviation (ADD) is calculated as follows:

$$ADD = {\sum }_{I = 1}^{17} \frac{\vert d - di \vert}{17}$$

where: 17 is the number of samples taken from the entire length of the Brett panel, d is the average density and di is the density of the ith sample. Compressive strength was measured according to EN 826. The test is performed on the 10 cm×10 cm×5 cm specimens cut from Brett panels in the directions perpendicular to rise along the foam thickness direction. Thermal conductivity was measured according to EN 12667 using a Lasercomp Fox 200 equipment. The test is performed on 20 cm×20 cm×2.5 cm specimens cut from the same position in the Brett molded panels from all the Ex and CE. The dimensional stability (DS) test was performed according to EN 1604 standard. Test specimens of 9 cm×9 cm×3.5 cm in size are tested under dry heat aging conditions: 80° C. for 1 day. Results are reported as % linear variation in the three space directions: width, length and thickness.

Aesthetics/defects was evaluated on foam panels prepared from the Super Brett mold at room temperature. This condition is chosen to more closely mimic the practical foam fabrication conditions used by water heater manufacturers. Polyurethane foams up to 75 mm thickness are sometimes molded for use in water heaters and more defects tend to show up at thicker molded foams. All bubbles that are visually identifiable on the surface were marked on the foam 30 minutes after demolding. A quantitative analysis of defects formation was made by manually counting the number of bubbles having their diameter larger than 3 mm. The average value of the front and back side was reported for each panel.

Thermal conductivity of the molded PU foams aged at room temperature over an extended period of time was also measured. A smaller reduction in thermal conductivity over time is highly desirable for better energy efficiency during long term use.

The Ex and CE are described in Table 1. Details of foam processing and the resulting foam properties for Ex and CE are summarized in Table 2 and Table 3.

Ex 1 presents an inventive foam formulation with Opteon® 1100 as the physical blowing agent. This formulation shows excellent shelf life stability even in absence of formic acid. The average hydroxyl functionality of the polyols used in Ex 1 is 3.6, the average hydroxyl number is 356, and the average molecular weight per crosslink is 439 g/mol.

Ex 2 shows a foam formulation with an even lower amount of high functionality polyether polyol than Ex 1 and an increased amount of low functionality polyether polyols. The average hydroxyl functionality of polyols in Ex 2 is at 3.4, the average hydroxyl number is 356, and the average molecular weight per crosslink is 468 g/mol.

Ex 3 shows another inventive foam formulation including a third polyether polyol with relatively high functionality of 4.6. The average hydroxyl functionality of polyols used in Ex 3 is 3.5, and the average molecular weight per crosslink is 450 g/mol. Both values are intermediate between Ex 1 and Ex 2.

Ex 4 shows an inventive foam formulation having an average hydroxyl functionality of 3.4, and the molecular weight per crosslink is 489 g/mol.

CE A shows a comparative foam formulation with Solstice® LBA as the physical blowing agent. This formulation contains a large amount of high functionality polyether polyol and a relatively small amount of low functionality polyether polyols (diols and triols) as compared to Ex 1. The average hydroxyl functionality of polyols used in CE A is 4.2, and the average molecular weight per crosslink is 403 g/mol. Additionally, formic acid is used even at just relatively low amount to provide shelf life stability of the fully formulated polyol blend.

CE B shows a comparative foam formulation similar to that of CE A, but Opteon®1100 is used as the physical blowing agent. A slightly larger amount of water is used to maintain comparable free rise density due to higher molecular weight of Opteon® 1100 versus Solstice® LBA.

CE C shows a comparative foam formulation similar to that of CE B, but no formic acid is used. A slightly larger amount of water is used to maintain comparable free rise density. The catalyst amount is also adjusted to maintain similar reactivity profile.

CE D shows a comparative foam formulation similar to that of Ex 1, but Solstice® LBA is used as the physical blowing agent. No formic acid is used. CE D shows poor shelf life stability that is not commercially useful.

TABLE 1
Ex and CE Formulations.

| | Ex 1 | Ex 2 | Ex 3 | Ex 4 | CE A | CE B | CE C | CE D |
|---|---|---|---|---|---|---|---|---|
| VORANOL ™ RN 482 | 24.6 | 12.0 | 15.0 | 9.0 | 39.3 | 39.1 | 40.0 | 24.9 |
| VORANOL ™ CP 1055 | 9.4 | 8.4 | 7.4 | 15.0 | 14.7 | 14.7 | 15.4 | 9.4 |
| VORANOL ™ CP 450 | 31.7 | 40.0 | 32.0 | 39.0 | 0.0 | 0.0 | 0.0 | 31.7 |
| VORANOL ™ CP 260 | 14.7 | 20.0 | 18.0 | 17.4 | 0.0 | 0.0 | 0.0 | 14.7 |
| VORANOL ™ RH 360 | 0.0 | 0.0 | 8.0 | 0.0 | 19.2 | 19.2 | 20.0 | 0.0 |
| VORANOL ™ P1010 | 0.0 | 0.0 | 0.0 | 0.0 | 5.0 | 5.0 | 5.0 | 0.0 |
| Water | 3.0 | 3.0 | 3.0 | 3.0 | 1.8 | 2.0 | 3.0 | 2.7 |
| Formic Acid | 0.0 | 0.0 | 0.0 | 0.0 | 0.9 | 0.9 | 0.0 | 0.0 |
| Tegostab ® B 8491 | 2.5 | 2.5 | 2.5 | 2.5 | 0.0 | 0.0 | 2.5 | 2.5 |
| Niax ™ L-6988 | 0.0 | 0.0 | 0.0 | 0.0 | 3.0 | 3.0 | 0.0 | 0.0 |
| DMBA | 2.2 | 2.2 | 2.2 | 2.2 | 2.4 | 2.4 | 2.2 | 2.2 |
| DMCHA | 0.9 | 0.9 | 0.9 | 0.9 | 2.4 | 2.4 | 0.9 | 0.9 |
| PMDETA | 0.3 | 0.3 | 0.3 | 0.3 | 0.2 | 0.2 | 0.3 | 0.3 |
| Dabco ® TMR-2 | 0.0 | 0.0 | 0.0 | 0.0 | 0.4 | 0.4 | 0.0 | 0.0 |
| Opteon ® 1100 | 10.7 | 10.7 | 10.7 | 10.7 | 0.0 | 10.7 | 10.7 | 0.0 |
| Solstice ® LBA | 0.0 | 0.0 | 0.0 | 0.0 | 10.7 | 0.0 | 0.0 | 10.7 |
| Total (wt. %) | 100.0 | 100.0 | 100.0 | 100.0 | 100.0 | 100.0 | 100.0 | 100.0 |
| VORANATE ™ M 220 | 145 | 146 | 145 | 139 | 112 | 116 | 130 | 140 |
| (parts by weight) | | | | | | | | |
| Ave. Hydroxyl Number, | 356 | 356 | 354 | 331 | 288 | 288 | 295 | 352 |
| mg KOH/g | | | | | | | | |
| Isocyanate Index | 1.11 | 1.11 | 1.11 | 1.11 | 1.10 | 1.10 | 1.12 | 1.11 |
| Average Functionality | 3.6 | 3.4 | 3.5 | 3.4 | 4.2 | 4.2 | 4.2 | 3.6 |
| Average Cross-Linking | 439 | 468 | 450 | 489 | 403 | 403 | 403 | 438 |
| Molecular Weight | | | | | | | | |
| Stability of fully | Stable | Stable | Stable | Stable | Stable | Stable | Stable | Poor |
| formulated polyol blends | | | | | | | | |
| after 4 weeks at 40 °C | | | | | | | | |

TABLE 2
High Pressure Foam Evaluation Results

| | Ex 1 | Ex 2 | Ex 3 | Ex 4 | CE A | CE B | CE C | CE D |
|---|---|---|---|---|---|---|---|---|
| Foam Characterization | | | | | | | | |
| Cream Time (sec) | 7 | 7 | 7 | 6 | 8 | 7 | 7 | 8 |
| Gel Time (sec) | 45 | 47 | 45 | 47 | 48 | 46 | 46 | 49 |
| Free Rise Density | 30.2 | 30.7 | 30.4 | 30.4 | 29.6 | 30.5 | 29.5 | 30.1 |
| (FRD, kg/m3) | | | | | | | | |
| BRETT (mold T = 40 °C) | | | | | | | | |
| Flow Index (MFD/FRD) | 1.23 | 1.18 | 1.19 | 1.20 | 1.3 | 1.26 | 1.20 | 1.22 |
| Molded Density (Kg/m3) | 40.8 | 39.9 | 39.7 | 40.2 | 42.5 | 42.6 | 39.2 | 40.0 |
| Core Density (kg/cm³) | 36.0 | 35.5 | 35.2 | 35.4 | 36.8 | 37.0 | 34.8 | 36.1 |
| ADD | 0.274 | 0.208 | 0.246 | 0.206 | 0.727 | 0.812 | 0.430 | 0.157 |
| Avg. CS Overall (kPa) | 210 | 203 | 202 | 199 | 189 | 199 | 182 | 190 |
| K-factor 10 °C (mW/mK) | 19.9 | 20.0 | 19.9 | 20.1 | 20.0 | 19.9 | 19.8 | 19.9 |
| K-factor 24 °C (mW/mK) | 21.4 | 21.5 | 21.5 | 21.7 | 21.4 | 21.3 | 21.3 | 21.4 |
| DS (after aging at 80 °C) | | | | | | | | |
| Avg width linear variation % | −0.2 | −0.2 | −0.2 | −0.3 | −0.6 | −0.5 | −0.1 | −0.1 |
| Avg advance linear variation % | −0.2 | −0.1 | −0.3 | −0.5 | −0.4 | −0.3 | −0.3 | 0.0 |
| Avg thickness linear variation | −0.2 | 0.1 | 0.0 | −0.1 | −0.5 | −0.3 | −0.4 | 0.5 |
| % | | | | | | | | |
| Super Brett (mold T = 25 °C) | | | | | | | | |
| Molded Density (Kg/m³) | 40.4 | 40.3 | 39.9 | 39.3 | 41.9 | 41.9 | 38.8 | 39.5 |
| Blister Front | + | ++ | ++ | =/+ | Ref | =/+ | =/+ | Not |
| | | | | | | | | Tested |
| Blister Back | + | ++ | ++ | ++ | Ref | = | =/+ | Not |
| | | | | | | | | Tested |
| Molded Density (Kg/m³) | 41.3 | 41.7 | 40.3 | 40.8 | — | 43.8 | 40.3 | 41.0 |
| Blister Front | =/+ | = | + | =/+ | Ref | = | = | Not |
| | | | | | | | | Tested |
| Blister Back | + | ++ | +++ | ++ | Ref | =/+ | + | Not |
| | | | | | | | | Tested |

+ Improved;
++ Significantly Improved;
+++ Very Significantly Improved;
=/+ Equal to Slightly Improved

TABLE 3
Thermal conducitity results of foams after aged at room temperature for a
different period of time: measured at 24 °C (mW/mK)

| Days | CE A | Ex 1 |
|---|---|---|
| 1 | 21.4 | 21.4 |
| 22 | 24 | 22.1 |
| 50 | 25.5 | 22.9 |
| 78 | 26.0 | 24.1 |
| 106 | 27.0 | 25.3 |
| 134 | 27.3 | 25.5 |
| 162 | 27.6 | 26.1 |
| 190 | 28.2 | 26.5 |

Results in Table 2 and Table 3 and from the aesthetics analysis show the fully formulated formulations of the present disclosure are significantly more advantaged than the existing foam systems for the manufacturing of rigid polyurethane foams. Excellent foam properties are achieved in terms of an improved insulation over the long term use, good mechanical properties at a lower foam density, and significantly reduced foam surface defects.

1. A composition for producing a rigid polyurethane foam, comprising:
an isocyanate component that includes at least one polyisocyanate; and
an isocyanate reactive system comprising:
5 to 30 weight percent (wt. %) of a first polyether polyol having an average hydroxyl number of from 100 to 600 mg KOH/g and an average hydroxyl functionality from 5.5 to 8;
45 to 75 wt. % of at least one second polyether polyol having an average hydroxyl number of from 75 to 800 mg KOH/g and an average hydroxyl functionality from 2 to 3.2;
1 to 20 wt. % of a hydrofluoroolefin physical blowing agent;
1 to 5 wt. % of a chemical blowing agent comprising water;
0.5 to 5 wt. % of at least one surfactant; and
0.5 to 6 wt. % of at least one catalyst,
wherein the wt. % are based on the total weight of the isocyanate reactive system, wherein the wt. % of the first polyether polyol, the at least one second polyether polyol, the hydrofluoroolefin physical blowing agent, the chemical blowing agent, the at least one surfactant and the at least one catalyst total 100 wt. % and wherein the isocyanate reactive system has an average hydroxyl functionality from 3.3 to 3.7, an average hydroxyl number from 300 to 400 mg KOH/g and does not contain formic acid.

2. The composition of claim 1, wherein the isocyanate reactive system includes 5 to 15 wt. % of a third polyether polyol having an average hydroxyl number of from 100 to 750 mg KOH/g and an average hydroxyl functionality from greater than 3.2 to 5;
wherein the wt. % of the first polyether polyol, the at least one second polyether polyol, the third polyether polyol, the hydrofluoroolefin physical blowing agent, the chemical blowing agent, the at least one surfactant and the at least one catalyst total 100 wt. %.

3. The composition of claim 1, wherein the first polyether polyol is 5 to 25 wt. % of the isocyanate reactive system and the at least one second polyether polyol is 50 to 72 wt. % of the isocyanate reactive system.

4. The composition of claim 1, wherein the at least one second polyether polyol comprises at least one glycerine-initiated polyether polyol having a number average molecular weight in the range of 150 to 1500 g/mol.

5. The composition of claim 1, wherein the at least one second polyether polyol comprises 5 to 20 wt. % of a first glycerine-initiated polyether polyol having a number average molecular weight of 800 to 1200 g/mol; 30 to 45 wt. % of a second glycerine-initiated polyether polyol having a number average molecular weight of greater than 350 to 650 g/mol; and 10 to 25 wt. % of a third glycerine-initiated polyether polyol having a number average molecular weight of 150 to 350 g/mol, where the wt. % values of the first glycerine-initiated polyether polyol, the second glycerine-initiated polyether polyol and the third glycerine-initiated polyether polyol provide the 45 to 75 wt. % of the at least one second polyether polyol.

6. The composition of claim 1, wherein the hydrofluoroolefin physical blowing agent is 1,1,1,4,4,4-hexafluoro-2-butene.

7. The composition of claim 1, wherein the isocyanate component and the isocyanate reactive system react to produce a rigid polyurethane foam having an average cross-linking molecular weight from 420 to 500 g/mole.

8. The composition of claim 1, wherein the composition has an isocyanate index from 100 to 150.

9. A rigid polyurethane foam prepared from the composition of claim 1, wherein the foam has a core density of greater than 30 kg/m³.

10. The rigid polyurethane foam of claim 9, wherein the foam is applied to a water heater.
